(19) United States
(12) Patent Application Publication
(10) Pub. No.: US 2023/0078848 A1
(43) Pub. Date: Mar. 16, 2023

(54) Generation of Carbon Nanotubes (CNTs) from Polyethylene Terephthalate (PET) in the Presence of Additives

(71) Applicant: Northeastern University, Boston, MA (US)

(72) Inventors: Yiannis A. Levendis, Boston, MA (US); Aidin Panahi, Braintree, MA (US); Chuanwei Zhuo, Lexington, MA (US)

(21) Appl. No.: 17/800,366

(22) PCT Filed: Feb. 19, 2021
(86) PCT No.: PCT/US2021/018776

§ 371 Date: Aug. 17, 2022

Related U.S. Application Data
(60) Provisional application No. 62/978,606, filed on Feb. 19, 2020.
(60) Provisional application No. 62/978,609, filed on Feb. 19, 2020.

(51) Int. Cl. C01B 32/16

(52) U.S. Cl. CPC C01B 32/16; B82Y 30/00

(57) ABSTRACT

Carbon nanostructures are synthesized from a feedstock that includes polyethylene terephthalate. In a first furnace, the feedstock that includes polyethylene terephthalate and calcium oxide (CaO) or calcium hydroxide (Ca(OH)₂) are pyrolyzed to obtain one or more gaseous decomposition products. The gaseous decomposition productions are optionally filtered to remove any solid particles. The one or more gaseous decomposition products are passed across a stainless steel substrate in a second furnace to form the carbon nanostructures.

### RELATED APPLICATIONS

This application claims the benefit of U.S. Provisional Application No. 62/978,606, filed on Feb. 19, 2020. This application also claims the benefit of U.S. Provisional Application No. 62/978,609, filed on Feb. 19, 2020. The entire teachings of the above applications are incorporated herein by reference.

### BACKGROUND

Carbon nanostructures can be generated by pyrolysis of organic materials, as described in WO 2010/111624 A1, U.S. Pat. No. 9,051,185 B2, and U.S. Pat. No. 9,738,524 B2. However, conversion of polyethylene terephthalate into carbon nanostructures has proven challenging.

### SUMMARY

The methods described herein involve pyrolytic or mildly oxidative decomposition of polyethylene terephthalate, either virgin or post-consumer, used as feedstock to generate carbon-bearing gases. These gases are used as donors for growth of carbon nanotubes on catalyst substrates, at temperatures in the range of 600-1200° C.

Pretreated metals, such as stainless steel materials (fixed or floating), can be used to act as catalysts for CNT growth. The pre-treatment of the catalysts involves acid wash for a period of time (e.g., 10 min), followed by oxidation in air at high temperatures (e.g., 800° C.) for a period of time (e.g., 1 min), followed by rapid quenching to room temperature.

Typically, the grown carbon nanotubes are removed by sonication in alcohol.

Described herein is a method for synthesizing carbon nanostructures. The method involves pyrolyzing i) a feedstock that includes polyethylene terephthalate and ii) calcium oxide (CaO) or calcium hydroxide (Ca(OH)₂), in a non-oxidizing environment in a first furnace having a temperature from 600° C. to 1200° C., to obtain one or more gaseous decomposition products. The method also involves optionally filtering the one or more gaseous decomposition productions to remove any solid particles from the one or more gaseous decomposition products; and passing the one or more gaseous decomposition products across a stainless steel substrate in a second furnace having a temperature from 600° C. to 1200° C. to form the carbon nanostructures.

The stainless steel substrate can be a wire mesh. The one or more gaseous decomposition products can be passed across a plurality of wire meshes. The stainless steel substrate can be stainless steel chips.

The non-oxidizing environment can include an inert gas, such as nitrogen. The non-oxidizing environment can include water vapor.

The method can further include mixing the one or more gaseous decomposition products with an oxidizing gas prior to passing the one or more gaseous decomposition products across the stainless steel substrate in the second furnace. The oxidizing gas can include oxygen. The oxidizing gas can be air.

The method can further include washing the stainless steel substrate in acid, heating the stainless steel substrate to at least 600° C., and quenching the stainless steel substrate prior to pyrolyzing.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIGS. 1A-B show the experimental laboratory equipment for pyrolysis of waste plastics and synthesis of carbon nanotubes (CNTs). FIG. 1A depicts generation of CNTs in a purely pyrolytic environment (e.g., in N2) or a mildly oxidative environment, where oxygen is introduced in a mixing venturi (1: pyrolysis stage, Zone 2: fuel-rich combustion stage*, and Zone 3: CVD-synthesis stage. A ceramic (SiC) honeycomb filter is shown, as well as a section of a stainless steel wire cloth, used as a catalyst substrate for CNT growth. A flame is present at the combustion stage only when oxygen-containing gases are added to the venturi. FIG. 1B is a schematic of an experimental setup.

FIGS. 2A-B are SEM images. FIG. 2C is a TEM image of a single CNT. FIGS. 2A-C are results from Successful Condition 1.

FIGS. 3A-B are SEM images. FIG. 3C is a TEM image of a single CNT. FIGS. 3A-C are results from Successful Condition 2.

FIGS. 4A-B are SEM images. FIGS. 4C-D are TEM images of a single CNT. FIGS. 4A-D are results from Successful Condition 3.

FIGS. 5A-B are SEM images. FIGS. 5A-B are results from Successful Condition 4.

FIGS. 6A-B are SEM images. FIGS. 6A-B are results from Successful Condition 5.

FIGS. 7A-B are SEM images. FIGS. 7A-B are results from Successful Condition 6.

FIGS. 8A-B are SEM images. FIGS. 8A-B are results from Successful Condition 7.

FIG. 9 is a photograph showing catalyst substrates used in these experiments. Top right: unused mesh coupon. Top middle: coupon with CNTs grown on it. Top left: quarter coin for size reference. Bottom: rolled-up mesh.

FIG. 10 is an SEM image.

### ABBREVIATIONS

CNT: Carbon nanotube

PET: Polyethylene terephthalate

PE: Polyethylene

LPM and lpm: Liters per minute

SEM: Scanning Electron Microscopy

TEM: Transmission Electron Microscopy

ID: Internal diameter

### DETAILED DESCRIPTION

A description of example embodiments follows.

The methods described herein relate to upcycling of waste plastics to value-added products, namely, carbon nanostructures or nanomaterials, such as carbon nanotubes (CNTs). In general, the methods involve metallic (e.g., stainless steel) substrates (fixed or floating) that are used as catalysts for the growth of nanotubes.

The feedstock can include polyethylene terephthalate. The feedstock is either pyrolyzed in an inert gas atmosphere or partially oxidized in a fuel-rich (oxygen-starved) atmosphere. Calcium oxide (CaO) and/or calcium hydroxide (Ca(OH)₂) are added to the feedstock. The CNTs are generated using the hydrocarbon-rich pyrolysis or oxidation products as carbon donors. Elevated temperatures in the range of 600-1200° C. are preferred for this process.

Stainless steel substrates can be immersed in an acid bath and then exposed to oxidative and thermal treatments to break up their protective chrome layer and activate their surfaces for nanocarbon generation. Thereupon, the ensuing pyrolyzate gases are passed by the substrates to catalytically grow CNTs on their surfaces. CNTs are then removed from the substrates by sonication in alcohol.

### Apparatus and Method

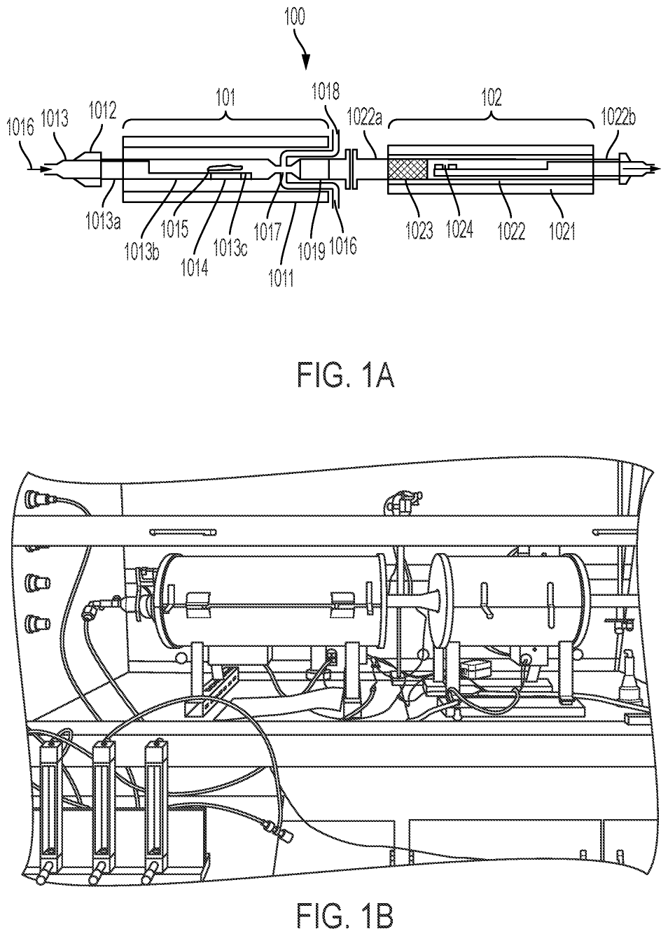

FIGS. 1A-B shows an apparatus 100 containing a primary furnace 101 and a secondary furnace 102 that is useful in generating carbon nanostructures. In certain embodiments, the primary furnace 101 can be a laminar flow muffle furnace and the secondary furnace 102 can be a laminar flow reactor.

As shown in FIG. 1A, the primary furnace 101 contains a primary furnace heating element 1011 to heat the primary furnace chamber 1012. Within the primary furnace chamber 1012, feedstock loading components 1013 can be provided, such as a quartz tube 1013a, which is cut to form a half tube 1013b, onto which a porcelain boat 1013c containing the organic material (polyethylene terephthalate) 1014 can be loaded. The organic material (polyethylene terephthalate) 1014 may be placed at desired or optimal positions within the primary furnace chamber 1012 to carry out pyrolysis therein to form pyrolyzates or gaseous decomposition products 1015.

In certain embodiments, the primary furnace chamber 1012 can contain an inlet 1016 to allow gases, such as an inert gas (e.g., nitrogen, argon, and the like), to enter the primary furnace chamber 1012 so that the pyrolyzation can occur under the desired conditions, such as under inert atmosphere.

The primary furnace 101 can further contain a venturi section 1017 near one end of the primary furnace chamber 1012 so that the gaseous decomposition products 1015 can enter the venturi section 1017. As would be understood by one of ordinary skilled in the art, a venturi section 1017 refers to a constricted section of the primary furnace chamber 1012 that cases a reduction in fluid pressure, which in turn causes an increase in the fluid velocity. Moreover, the venturi section 1017 need not be part of the primary furnace 101 but may be provided as a separate component that is connected to the primary furnace 101.

The venturi section 1017 can further be provided with one or more inlets 1018 that can introduce additional materials, such as one or more gases (e.g., oxidizing agents such as oxygen gas, chlorine gas, carbon dioxide, any other gas containing oxygen, and the like) to mix with the gaseous decomposition products 1015 that enter the venturi section 1017. In certain embodiments, the inlets 1018 can be positioned so that mixing occurs between the gaseous decomposition products 1015 and the one or more gases that enter through inlets 1018. In certain embodiments, the mixing can cause ignition (e.g., auto-ignition) leading to a sooting flame in the post-venturi section 1019. In other embodiments, the mixing can cause ignition and lead to a laminar flame in the post-venturi section 1019.

The post-venturi section 1019 can be connected to a secondary furnace 102, particularly to a first end 1022a of a secondary furnace chamber 1022. The secondary furnace 102 can contain a secondary heating element 1021 to heat the second furnace chamber 1022 to desired temperatures.

An optional filter 1023, such as a ceramic filter, can be included near the first end 1022a of the secondary furnace chamber 1022. However, the filter 1023 need not be part of the secondary furnace 102 but can be provided at any desired location between the primary furnace 101 and the secondary furnace 102. In embodiments where the flame in the post-venturi section 1019 contains particulates (e.g., soot or other particulates), the filter 1023 may act to filter out at least some, most, or all of the particulates from entering the second furnace chamber 1022. One or more filters can be utilized. For example, multiple filters can be stacked together, either placed parallel or in series to further increase the filter efficiency.

The second heating element 1021 may provide sufficient heating to allow the generation of carbon nanostructures in the second furnace chamber 1022. The second furnace 102 may further be equipped with other suitable components, such as a vacuum pump (not shown) and suitable connectors thereof (not shown) to provide sub-atmospheric conditions in the secondary furnace chamber 1022, that can further facilitate, promote, or enhance the formation of carbon nanostructures.

In certain embodiments, the secondary furnace chamber 1022 may contain catalyst 1024 that can aid in the formation of carbon nanostructures. In certain embodiments, the gaseous decomposition products from the post-venturi section 1019 can enter the secondary furnace chamber 1022 to contact the catalyst 1024 contained inside the secondary furnace chamber 1022. As the gaseous decomposition products contact the catalyst 1024, generation of carbon nanostructures can begin, be promoted, or be enhanced. In certain embodiments, the catalyst 1024 can be a supported catalyst that acts as both a catalyst and a carbon nanostructure collecting vessel or a substrate 1025 (not shown). In other embodiments, catalyst 1024 may be a separate component from the substrate 1025.

In certain embodiments, one or more catalysts 1024 can be utilized. For example, multiple stainless steel wire meshes or the like can be stacked together, placed parallel or in series (e.g., folded, rolled, and the like) to further increase the catalyst surface area. In some embodiments, the surface area of the catalyst can increase by 1,000 to several million times depending on the available secondary furnace chamber 1022 and design of apparatus 100.

The carbon nanostructures generated can then be collected from the substrate 1025 as would be readily apparent to one of ordinary skill in the art.

Variations and modifications to the apparatus 100 will be readily apparent to one of ordinary skill in the art and are within the scope of the present disclosure. For example, in certain embodiments, apparatus 100 can be a single furnace containing a primary section and a secondary section, and need not be embodied as two separate furnaces as exemplified in FIGS. 1A-B. Other variations and modifications are possible.

Polyethylene terephthalate can be pyrolyzed to form pyrolyzates or gaseous decomposition products. Pyrolysis can occur in the presence of one or more inert gases, such as nitrogen, argon, and the like, preventing ignition and combustion of the pyrolyzates or gaseous decomposition products therein.

In certain embodiments, pyrolysis can be carried out under conditions that allow greater than 80%, 85%, 90%, or even 95% conversion of the organic material (polyethylene terephthalate) to gaseous decomposition products. In certain embodiments, pyrolysis can be carried out at temperatures above 600° C., or above 700° C., or above 800° C., or above 900° C., or even above 1000° C. to maximize the amount of gaseous decomposition products. The temperature in each of the first and second furnaces can be independently adjusted. Typically, the temperature in each of the first and second furnaces is from 600° C. to 1200° C. In some embodiments, the temperature in the first furnace is from 600° C. to 1000° C. In some embodiments, the temperature in the second furnace is from 600° C. to 1000° C. In some embodiments, the temperature in the first furnace is from 800° C. to 1000° C. In some embodiments, the temperature in the second furnace is from 800° C. to 1000° C.

Gaseous decomposition products can be mixed with one or more gases, for example, a gas containing oxygen, to form a flame. The flame may be a sooting flame or a non-sooting flame.

In certain embodiments, to form a flame, the gaseous decomposition products can be released quasi-uniformly using a purposely-designed device (e.g., a continuous feeding system, a fluidizied bed, etc.), and passed into an area, such as the venturi section 1017 shown in FIG. 1A, to effectuate mixing with the one or more gases. Suitable gases to mix with the gaseous decomposition products include gas containing oxygen, such as air. Upon or during mixing, auto-ignition can occur to form a premixed flame.

In some embodiments, the one or more gases may be added at a quantity so that the fuel/oxygen ratio can be made fuel-rich (i.e., oxygen-deficient). Without wishing to be bound by theory, such oxygen-deficient condition may promote growth of carbon nanostructure growth by maintaining a sufficient amount of CO, hydrogen or other suitable feedstock such as small hydrocarbons in the flame.

In certain embodiments, the one or more gases may not contain oxygen or can contain additional gases in addition to oxygen. For example, inert gases, such as, but not limited to, nitrogen, argon, and the like, can be added mixed with the gaseous decomposition products. In certain embodiments, the presence of these other gases may prevent formation of a flame. Rather than forming a flame, the gaseous decompositions products may pass into an area capable of generating carbon nanostructure, such as the secondary furnace chamber 1022 shown in FIGS. 1A-B, after being channeled through the particulate filter to form carbon nanostructures.

In embodiments where flame is established, the premixed flame can partially penetrate into the ensuing secondary furnace 1022. In some embodiments, the premixed flame effluents can pass through a filter 1023 to filter out one or more particulates contained in the flame.

The effluents of the flame may then pass through a filter, such as a filter 1023, or any other filter capable of operating under high temperature conditions. The filter can trap at least some solid particles (e.g., soot) before the effluents of the flame is introduced into an area capable of generating carbon nanostructures, such as the secondary furnace chamber 1022 shown in FIGS. 1A-B. In certain embodiments, the filter can further act as a flow straightener before the effluents of the flame enter into the secondary furnace chamber 1022.

In some embodiments, absence of oxygenate gases, and non-sooting combustion conditions, can allow for the omission of the filter.

Upon entry into the area capable of generating carbon nanostructures, carbon nanostructures can form. In certain embodiments, the area capable of generating carbon nanostructures, such as the secondary furnace 102, can be maintained at conditions that promote the generation of carbon nanostructures, such as the synthesis temperature ranging from 600° C. to 1500° C., effluent flow velocities ranging from 0.1 cm/s to 10 cm/s, associating with the apparatus 100, and the like.

In certain embodiments, the area capable of generating carbon nanostructures may include one or more catalysts that promote the generation of carbon nanostructures. In some embodiments, the catalyst is a fixed or supported catalyst, which is pre-inserted into the area capable of generating carbon nanostructures. In certain embodiments, the carbon nanostructures can be grown on top of the supported catalysts for subsequent collection.

Alternatively, the gaseous decomposition products can be used as a starting feedstock material for generation of carbon nanostructures in other nanostructure manufacturing processes, such as, but not limited to, chemical vapor deposition (CVD), flow reactor, fluidized beds using floating or supported catalysts, and the like. In such embodiments, any condensed particulates that form in pyrolysis can be removed through filtration of the condensed particulate before the gaseous decomposition products are provided in the nanostructure manufacturing processes. The filtered condensed particulates can be collected so that they are not emitted as environmental pollutants.

In some embodiments, oxygen, hydrogen, sulfur-containing compounds such as thiophene, or combination thereof, such as water vapors, can be added to the primary furnace chamber 1012, the venturi section 1017, or the secondary furnace chamber 1022 to promote activation and maintaining high catalytic activity of the catalysts. The range of the gas to be added may be from about 0.0001% (or 1 ppm) to about 80% by volume.

High-temperature pyrolysis of polymers generates mostly gases (hydrocarbons and hydrogen), with a small fraction of liquids (oils and tars). The oils can be condensed and removed for further use.

The remaining unreacted pyrolyzate hydrocarbon gases may be burned to generate heat for the process or marketed as a feedstock for other purposes (power generation or chemical feedstock). In addition, heat released during combustion can be recycled as heat to be used for pyrolyzation.

### Metallic Substrates

The metallic substrates used herein can have a variety of configurations, such as wire cloths, particles, waste chips or shreddings. Typically, the metallic substrate is made, at least partially, of stainless steel.

Stainless steels are alloys of iron, chromium, and, in some cases, nickel, molybdenum, manganese, or other metals. Typically, stainless steel contains at least 10-11% chromium and less than 2% carbon. Some types of stainless steel also include nitrogen, aluminium, silicon, sulfur, titanium, nickel, copper, selenium, and/or niobium.

A variety of stainless steel families are known, such as austenitic stainless steel, ferritic stainless steel, martensitic stainless steel, duplex stainless steel, and precipitation hardening stainless steel. Stainless steel are often classified by a three-digit number, such as 304 stainless steel, 316 stainless steel, etc.

Stainless steel substrates are immersed in an acid bath and then exposed to oxidative and thermal treatments to break up their protective chrome layer and activate their surfaces for nanocarbon generation. The acid bath can include hydrochloric acid (HCl) or sulfuric acid (H₂SO₄). The thermal treatment typically involves heating the substrate to at least 600° C. (e.g., approximately 800° C.). After heating the stainless steel substrate is quenched to reduce its temperature, which can be by air quenching or water quenching.

After generating CNTs, the substrates are again washed in acid and heated to remove any remaining carbon from the substrates and to increase the roughness of the surface.

Pyrolysis of Polyethylene Terephthalate with Calcium Oxide (CaO) and/or Calcium Hydroxide (Ca(OH)₂)

A limited number of studies have been reported on the pyrolysis of polyethylene terephthalate (PET), and they all agree that its pyrolysis products include large amounts of benzoic acid.

PET pyrolyzates consist of liquids, gases and solids. Lee et al. (2017) from Sejong University in Korea reported that 85% of the PET mass decomposes between 380 and 670° C. by thermal deconstruction (pyrolysis). Work by Yoshioka et al. (2004) at Tahoku University in Japan determined that at temperatures in the range of 510-630° C., 37-39% of the mass of PET results in gas, whereas Artetxe et al (2010) from the Basque University in Spain reported that 43-49% of the mass of PET convers to gas. The rest of the pyrolyzates are in the form of liquids and solids. According to Yoshioka et al (2004) and Artetxe et al (2010) most of the gaseous pyrolyzates consist of CO (10-20% of the polymer mass) and CO₂ (13-30% of the polymer mass) as well as small amounts (˜4%) of light hydrocarbons (ethylene, methane, propane, cyclo-butane, etc.). Benzoic acid in the pyrolysis products accounts for as much as 12-21% of the polymer mass.

The low yield of gaseous pyrolyzates from PET, particularly the very low content of hydrocarbons (HC) in the gas (˜4%) is not optimum for generation of nanotubes, as it is the hydrocarbons (but also the CO to some extent) that serve as carbon donors for their growth on the catalytic substrates.

An extensive literature search revealed that benzoic acid is not an appropriate carbon donor substance for CNT generation, see the work of Yu et al. (2015) at Shangrao Normal University in China. Those researchers generated CNTs from benzene and several phenols, but could not generate CNTs from benzoic acid. They attributed this problem to (a) synergistic effects between electron-withdrawing groups impeding dehydrogenation of benzene rings, thus keeping them stable, and (b) catalyst poison rendering the catalyst inert. Accordingly, we hypothesized that suppressing generation of benzoic acid in the pyrolysis of PET would allow for production of CNTs.

Research at Tohuku University in Japan (Yoshioka et al. (2005), Kumagai et al. (2015), Kumagai et al. (2018)) documented that pyrolysis of PET in the presence of calcium oxide (CaO, lime) or calcium hydroxide (Ca(OH)₂, hydrated lime) additives can lead to decarboxylation of the resulting terephthalic acid, further resulting in increased amounts of benzene instead of benzoic acid. Benzene is considered to be an effective carbon donor for CNT growth. Additional benefit of using lime and hydrated lime, aside of being cheap commodities (annual global production being ˜350 million tons), are that both will not be consumed throughout the pyrolysis process and both can be regenerated for long-term usage.

Accordingly, we hypothesized that including lime (CaO) or hydrated lime (Ca(OH)₂), along with the feedstocks, would increase production of CNTs. Therefore, experiments were conducted to further concentrate on adding powders of calcium hydroxide (hydrated lime) or calcium oxide (lime) to PET and then pyrolyzing the PET+additive mixture.

In the present disclosure, rather than using expensive and highly purified premium fuels for combustion or CVD process, methods and apparatus to generate of carbon nanostructures using solid organic materials, such as solid waste materials, including solid plastics in the form of pellets, chips, chunks, and the like, as the starting material is described. The organic material used herein is polyethylene terephthalate, which can be mixed with other organic materials, such as polyethylene.

In some embodiments, the solid organic material (polyethylene terephthalate) can be in the form of pellets, chips, chunks, or combinations thereof. In yet some other embodiments, the solid organic material can contain various groups, such as an alcohol, alkane, alkene, alkyne, aromatic, acrylate, cellulose, or combinations thereof. Other solid organic materials can be used, such as, but not limited to, biomass, corn, cotton, rubber, tire, coal, wood, lignin, or combinations thereof.

In some embodiments, liquid organic material (polyethylene terephthalate) can be utilized.

Calcium oxide (CaO, lime) and/or calcium hydroxide (Ca(OH)₂, hydrated lime) are added to the polyethylene terephthalate. The calcium oxide and/or calcium hydroxide can be mixed with the polyethylene terephthalate. In other embodiments, powders of the calcium oxide and/or calcium hydroxide can be suspended in water and sprayed onto the polyethylene terephthalate.

### Carbon Nanostructres

Carbon nanostructures include, but are not limited to, carbon nanofibers with or without hollow cavity, and spherical multi-layer onion carbons. Fiber walls can include amorphous carbon or graphitic structures of different degrees of perfection. Hollow carbon nanofibers with graphitic wall structures containing parallel walls are called carbon nanotubes. Carbon nanotubes are defined based on the number of parallel walls: single-walled nanotubes, double-walled nanotubes, triple-walled nanotubes, and so forth. Generally, carbon nanotubes having multiple number of walls are called multi-walled nanotubes.

### Applications

Carbon nanostructures generated by the methods described herein can be used in a variety of applications.

Major fields of interest including the following nanotube products and their actuators in the conversion of electrical energy to mechanical energy and vice versa, use in robotics, optical fiber switches, displays, and prosthetic devices. Other applications include energy harvesting, batteries, composites, electrostatic dissipation (ESD), and preparation of tires.

For example, carbon nanostructures can be used as electrode material in batteries, either exclusively or as additive, for instance increasing electrical conductivity.

Due to their thermal conductivity, carbon nanostructures such as carbon nanotubes can be used for heat dissipation in electronic devices.

In another example, nanotubes can be used as sensors as correlations between adsorption of gases such as oxygen and conductance and thermoelectric power have been observed. Additional examples include use of nanotubes as composites in a polymer-nanotube combination where improved strength performance is observed. Further enhancements can be obtained by functionalizing the nanotube walls so that nanotube can be anchored to polymeric structures.

In addition, because their physical dimensions are similar to those of biologically active macromolecules such as proteins and DNA, CNTs are useful in biology-related applications, including, but not limited to, detection, drug delivery, enzyme immobilization, and DNA transfection.

Depending on structural characteristics, CNTs can be metallic or semiconducting. The sizes of transistors and logic devices can be reduced significantly using CNTs. For example, a logic device can be made of a single nanotube with a transition between chiralities along its length. Additionally, highly-ordered carbon nanotube arrays can be used for a variety of electronics application ranging from data storage, display, and sensors to smaller computing devices. Commercial application of carbon nanotubes in the area of flat panel displays (FPD) is also credible.

CNTs are also useful as hydrogen storage materials. For example, single-walled nanotubes are suitable for hydrogen storage systems necessary in hydrogen-powered vehicles.

### EXEMPLIFICATION

A description of example embodiments follows.

### Example #1

Recycled toner cartridge packages, containing 90% PET and 10% PE were used as feedstocks.

The toner cartridge feedstock was shredded and then fed into an existing lab-scale batch reactor. The reactor consists of quartz glassware, heated by two electric furnaces, shown in FIGS. 1A-B. The experimental setup incorporates four stages: (a) a polymer pyrolysis in inert gas, (b) a venturi that allows mixing with other input gases, if needed, (c) a high temperature ceramic filter, and (d) a stage for CNT synthesis on catalyst substrates. Shredded samples of the supplied materials were loaded in porcelain boats and inserted into the purged and preheated pyrolysis section of the reactor. Nitrogen served as the inert carrier gas ensuring that non-oxidizing conditions prevailed in the polymer pyrolysis section. The pyrolyzate gases passed into the venturi (8 mm ID), where at some conditions they were mixed with oxygen.

The resulting gases were channeled into the third stage of the apparatus where they passed through a high-temperature ceramic SiC filter (supplied by Ibiden Corp.) to remove any generated solid particles (soot, etc.). Filtration prevents catalyst deactivation by deposition of soot thereupon. This filter has a retention efficiency of 97% for soot particles bigger than 1 μm, and was periodically thermally-regenerated by passing high-temperature air. Thereafter, the filtered gases were passed through a number (usually four) of metallic screen coupons placed perpendicularly to the flow of the gases.

Initiation and completion of the feedstock pyrolysis, and the simultaneous CNT synthesis reactions, were inferred by monitoring the evolution of visible fumes in the effluent of the reactor. Upon termination of each run, the furnaces were turned off and the reactor was allowed to cool down to room temperature. The screens were then removed and sections therefrom were cut and prepared for analysis by Scanning Electron Microscopy (SEM). Other screen sections were sonicated in ethyl alcohol for a brief period of time (10 min) to remove CNTs for additional analysis by Transmission Electron Microscopy (TEM).

Three types of catalyst substrate screens were tested: Type 316 stainless steel, nickel, and/or plain carbon steel. The former was the most successful. When 316 stainless steel was used, it was first acid washed with a dilute hydrogen chloride solution, rinsed with de-ionized water, heated at 800° C. in air for one minute, and then rapidly quenched in a jet of compressed air. See Panahi et al., “Influence of Stainless-Steel Catalyst Substrate Type and Pretreatment on Growing Carbon Nanotubes from Waste Postconsumer Plastics,” Ind. Eng. Chem. Res. 2019, 58, 3009-3023.

The following reactor operating parameters were varied in the denoted ranges:

Polymer pyrolysis temperatures: 600-800° C.; CNT synthesis temperatures: 800-1000° C.; sample amounts: 2-4 grams per batch; nitrogen purging flowrate: 1-3 liters/minute.

Some experiments were conducted in the presence of lime or calcium oxide (CaO) or calcium hydroxide (Ca(OH)₂). On these occasions the package shreddings were physically mixed/coated with additives before being loaded into the pyrolysis chamber.

### Experimental Matrix

More than 30 tests were conducted using these materials as feedstock for the lab-scale batch reactor. Some operating conditions resulted in carbon nanotubes while others did not. The conditions that yielded CNTs are summarized in Table 1. Conditions that did not yield CNTs involved using nickel substrates and carbon steel substrates.

TABLE 1
Experimental matrix for the experimental conditions that successfully yielded CNTs from feedstocks.

| | | | | | | | Yield | Yield | Diameter | Approx |
|---|---|---|---|---|---|---|---|---|---|---|
| | | | | N₂ | O₂ | Polymer | (weight | (weight | of the | length |
| Successful | | | | flow | flow | mass | % CNT/ | % CNT/ | CNT | of CNT |
| Condition | Additive | T_{pyrolysis} | T_{synthesis} | (Ipm) | (Ipm) | (g) | catalyst) | polymer) | (nm) | (μm) |
| 1 | None | 800 | 800 | 2 | 0 | 4 | 0.9% | 0.3% | 217 | — |
| 2 | None | 600 | 1000 | 1.7 | 0.3 | 4 | 4% | 0.5% | 182 | >35 |
| 3 | Ca(OH)₂ | 600 | 1000 | 2 | 0 | 2 | 3.4% | 0.94% | 232 | >100 |
| 6 | CaO | 600 | 1000 | 2 | 0 | 2 | 4.4% | 1.2% | 517 | >20 |
| 5 | CaO | 700 | 1000 | 2 | 0 | 2 | 4.7% | 1.0% | 234 | >40 |
| 4 | Ca(OH)₂ | 700 | 1000 | 2 | 0 | 2 | 3.3% | 0.9% | 335 | >20 |
| 7 | CaO | 600 | 1000 | 3 | 0 | 2 | 3.4% | 0.8% | 257 | >60 |

In all of these experiments the total weight of the three of catalyst mesh coupons was approximately 0.6 g. The corresponding experimental settings and the resulting CNT SEM images are described in the Results and Discussion section.

### Results

In the following Successful Conditions 1-7, powdered CaO was sprinkled as a coating over a bed of the polymer.

### Successful Condition 1

Feedstock: 90% PET+10% PE

Catalyst: SS 316, Nitrogen gas

Substrate treatment: Acid wash by HCl, Heat treatment in air for 1 min and then air quench

Process temperature: Pyrolysis furnace: 800° C., Synthesis furnace: 800° C.

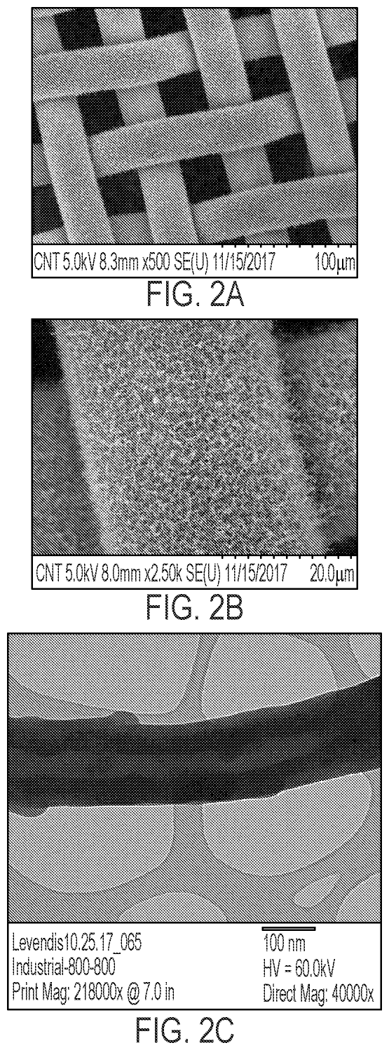

FIGS. 2A-B are SEM images of CNTs generated from this experiment. FIG. 2C is a TEM image of a single CNT generated from this experiment.

### Successful Condition 2

Feedstock: 90% PET+10% PE

Catalyst: SS 316

Nitrogen gas, with the addition of 15% of O2, Total flowrate 2 lpm

Substrate treatment: Acid wash by HCl, Heat treatment in air for 1 min and then air quench

Process temperatures: Pyrolysis furnace: 600° C., Synthesis furnace: 1000° C.

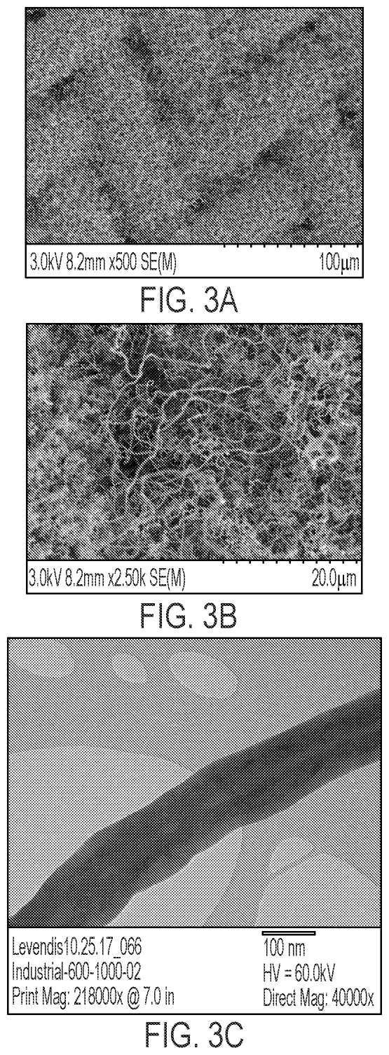

FIGS. 3A-B are SEM images of CNTs generated from this experiment. FIG. 3C is a TEM image of a single CNT generated from this experiment.

### Successful Condition 3

Feedstock: 90% PET+10% PE+Ca(OH)₂

Catalyst: SS 316

Nitrogen gas at 2 lpm.

Substrate treatment: Acid wash by HCl, heat treatment in air for 1 min and then quenched

Process temperatures: Pyrolysis furnace: 600° C., Synthesis furnace: 1000° C.

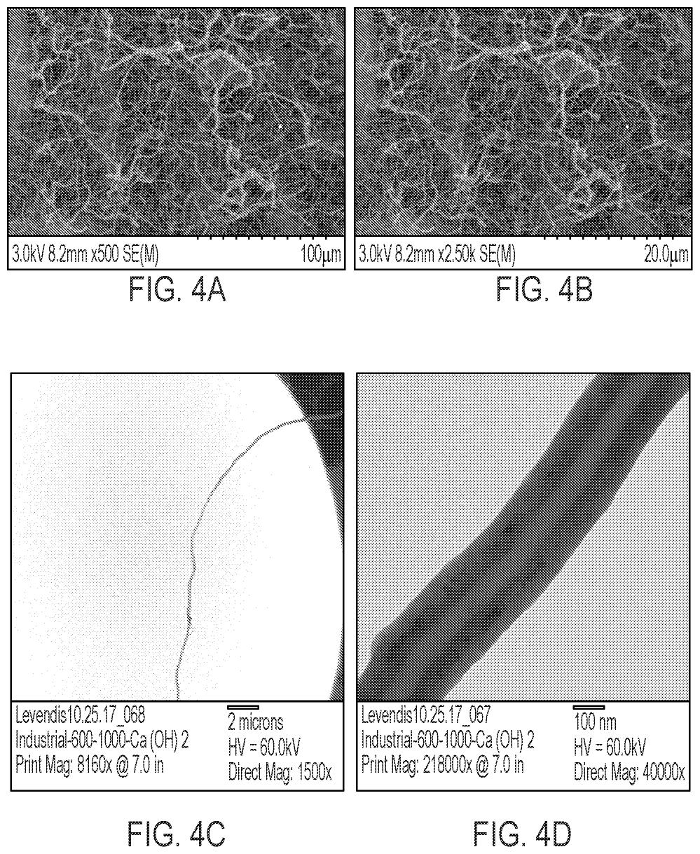

FIGS. 4A-B are SEM images of CNTs generated from this experiment. FIG. 4C-D are TEM images of a single CNT generated from this experiment.

### Successful Condition 4

Feedstock: 90% PET+10% PE+Ca(OH)₂

Catalyst: SS 316

Nitrogen flow rate 2 lpm.

Substrate treatment: Acid wash by HCl, heat treatment in air for 1 min and then quenched

Process temperatures: Pyrolysis furnace: 700° C., Synthesis furnace: 1000° C.

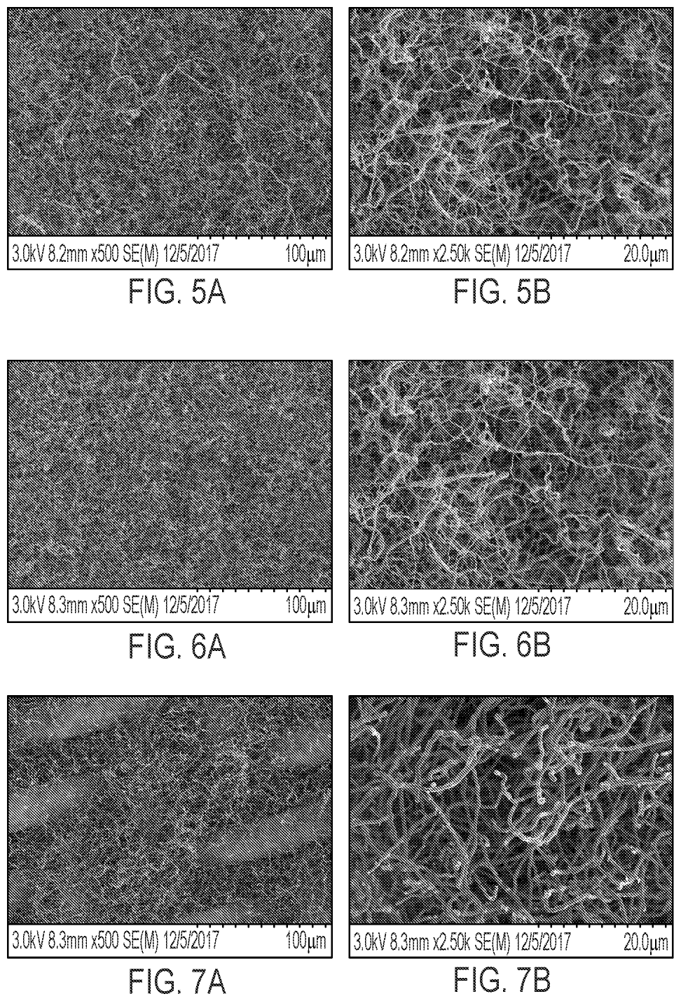

FIGS. 5A-B are SEM images of CNTs generated from this experiment.

### Successful Condition 5

Feedstock: 90% PET+10% PE+CaO

Catalyst: SS 316

Nitrogen flow rate 2 lpm.

Substrate treatment: Acid wash by HCl, heat treatment in air for 1 min and then quenched

Process temperature: Pyrolysis furnace: 700° C., Synthesis furnace: 1000° C.

FIGS. 6A-B are SEM images of CNTs generated from this experiment.

### Successful Condition 6

Feedstock: 90% PET+10% PE+CaO

Catalyst: SS 316

Nitrogen flow rate 2 lpm

Substrate treatment: Acid wash by HCl, heat treatment in air for 1 min and then quenched

Process temperatures: Pyrolysis furnace: 600° C., Synthesis furnace: 1000° C.,

FIGS. 7A-B are SEM images of CNTs generated from this experiment.

### Successful Condition 7

Feedstock: 90% PET+10% PE+CaO

Catalyst: SS 316, Nitrogen flow rate: 3 lpm

Substrate treatment: Acid wash by HCl, heat treatment in air for 1 min and then quenched

Process temperature: Pyrolysis furnace: 600° C., Synthesis furnace: 1000° C.

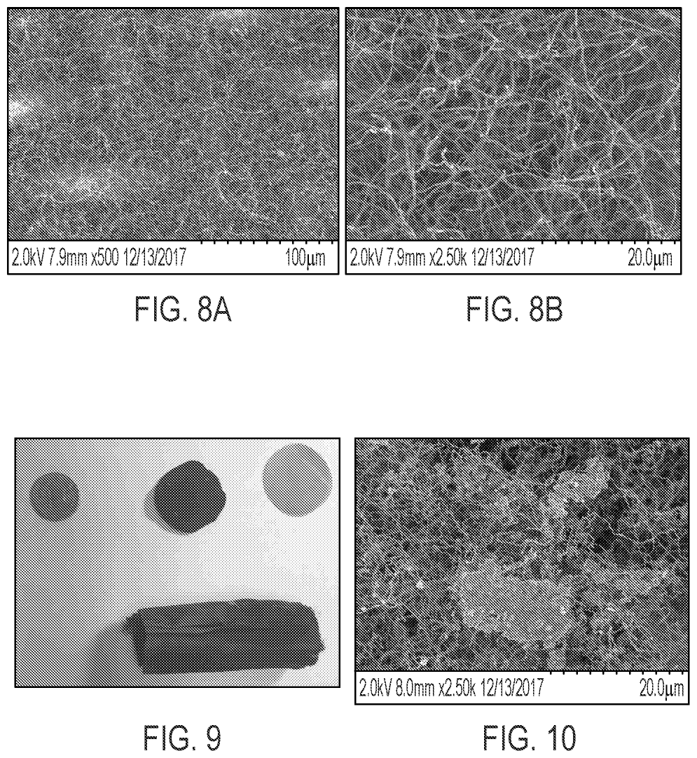

FIG. 8A-B are SEM images of CNTs generated from this experiment.

### Exploratory Experiment to Achieve Higher Yield

In this experiment a large piece of catalyst substrate mesh was used. Instead of using three round mesh coupons with a total weight of approx. 0.6 grams, a rolled up mesh of 14.6 g was used as shown in FIG. 9. 2 grams of polymer were pyrolyzed and 0.2 grams of material was collected on the catalyst substrate. Thus, the yield was approximately 10% of the polymer feedstock weight, however, SEM analysis showed that while a lot of CNTs were grown on the substrate, some other material was also condensed therein, perhaps tars.

Plastic: PET+CaO Catalyst: SS 316, Nitrogen flow rate 2 lpm.

Substrate treatment: Acid wash by HCl, heat treatment in air for 1 min and then quenched

Process temperature: Pyrolysis furnace: 600° C., Synthesis furnace: 1000° C.

FIG. 10 is an SEM image of CNTs generated from this experiment.

### REFERENCES

Lee et al. (2017): “Enhanced energy recovery from polyethylene terephthalate via pyrolysis in CO2 atmosphere while suppressing acidic chemical species.” J. Lee, T. Lee, Y F Tsang, J I. Oh, E E. Kwon—Energy Conversion and Management, 148 (2017) 456-460.

Yoshioka et al. (2004): “Pyrolysis of poly(ethylene terephthalate) in a fluidised bed plant.” Toshiaki Yoshioka, Guido Grause, Christian Eger, Walter Kaminsky, Akitsugu Okuwaki.—Polymer Degradation and Stability 86 (2004) 499-504.

Artetxe et al (2010): “Operating Conditions for the Pyrolysis of Poly-(ethylene terephthalate) in a Conical Spouted-Bed Reactor.” Maite Artetxe, Gartzen Lopez, Maider Amutio, Gorka Elordi, Martin Olazar, and Javier Bilbao. Industrial Engineering and Chemistry Research 49 (2010) 2064-2069.

Yu et al. (2015): “Synthesis of Carbon Nanotubes by Using a Series of Phenyl Derivatives as Precursors. Leshu Yu, Yingying Lv, Keyan Wu, and Chungen Li. Fullerenes, Nanotubes and Carbon Nanostructures 23 (2015) 1073-1076.

Yoshioka et al. (2005): “Effects of metal oxides on the pyrolysis of poly(ethylene terephthalate).” Toshiaki Yoshioka, Tomohiko Handa, Guido Grause, Zhigang Lei, Hiroshi Inomata, Tadaaki Mizoguchi. Journal of Analytical and Applied Pyrolysis 113 (2015) 584-590.

Kumagai et al. (2015): Thermal decomposition of individual and mixed plastics in the presence of CaO or Ca(OH)2. Shogo Kumagaia, Itaru Hasegawa, Guido Grause, Tomohito Kameda, Toshiaki Yoshioka. Journal of Analytical and Applied Pyrolysis 113 (2015) 584-590.

Kumagai et al. (2018): Aromatic hydrocarbon selectivity as a function of CaO basicity and aging during CaO-catalyzed PET pyrolysis using tandem μ-reactor-GC/MS. Shogo Kumagai, Ryota Yamasaki, Tomohito Kameda, Yuko Saito, Atsushi Watanabe, Chuichi Watanabe, Norio Teramae, Toshiaki Yoshioka. Chemical Engineering Journal 332 (2018) 169-173.

Panahi et al. (2019): Influence of Stainless-Steel Catalyst Substrate Type and Pretreatment on Growing Carbon Nanotubes from Waste Postconsumer Plastics” Ind. Eng. Chem. Res. 2019,58,3009-3023.

### INCORPORATION BY REFERENCE; EQUIVALENTS

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A method for synthesizing carbon nanostructures, the method comprising:
a) in a non-oxidizing environment in a first furnace having a temperature from 600° C. to 1200° C., pyrolyzing i) a feedstock comprising polyethylene terephthalate; and ii) calcium oxide (CaO) or calcium hydroxide (Ca(OH)₂), to obtain one or more gaseous decomposition products; and
b) passing the one or more gaseous decomposition products across a stainless steel substrate in a second furnace having a temperature from 600° C. to 1200° C. to form the carbon nanostructures.

2. The method of claim 1, wherein the stainless steel substrate is a wire mesh.

3. The method of claim 2, wherein the one or more gaseous decomposition products are passed across a plurality of wire meshes.

4. The method of claim 1, wherein the stainless steel substrate comprises stainless steel chips.

5. The method of claim 1, wherein the non-oxidizing environment comprises an inert gas.

6. The method of claim 5, wherein the inert gas is nitrogen. 7 The method of claim 1, wherein the non-oxidizing environment comprises water vapor.

8. The method of claim 1, further comprising mixing the one or more gaseous decomposition products with an oxidizing gas prior to passing the one or more gaseous decomposition products across the stainless steel substrate in the second furnace.

9. The method of claim 8, wherein the oxidizing gas comprises oxygen.

10. The method of claim 8, wherein the oxidizing gas is air.

11. The method of claim 1, further comprising washing the stainless steel substrate in acid, heating the stainless steel substrate to at least 600° C., and quenching the stainless steel substrate prior to performing steps a) through b).

12. The method of claim 1, further comprising filtering the one or more gaseous decomposition products to remove any solid particles from the one or more gaseous decomposition products prior to passing the one or more gaseous decomposition products across the stainless steel substrate in the second furnace.
